(19) United States
(12) Patent Application Publication
(10) Pub. No.: US 2014/0007381 A1
(43) Pub. Date: Jan. 9, 2014

(54) Foldable Handle

(71) Applicant: Chi-Haw Huang, Homei Changhwa (TW)

(72) Inventor: Chi-Haw Huang, Homei Changhwa (TW)

(21) Appl. No.: 13/542,797

(22) Filed: Jul. 6, 2012

(51) Int. Cl. E05B 7/00

(52) U.S. Cl. 16/421

(57) ABSTRACT

A foldable handle includes a grip portion, two pivot units each pivotally connected with the grip portion, two support members each mounted between the grip portion and a respective one of the pivot units, and two elastic members each biased between a respective one of the pivot units and a respective one of the support members. Thus, when the grip portion is hit by a person unintentionally, the grip portion is moved and rotated relative to each of the pivot units freely to reach a folded state so as to prevent the person from being hurt due to hit with the grip portion.

### BACKGROUND OF THE INVENTION

1. Field of the Invention

The present invention relates to a handle and, more particularly, to a foldable handle for a wardrobe, cupboard, door, drawer, cabinet, refrigerator and the like.

2. Description of the Related Art

A conventional handle “B” in accordance with the prior art shown in FIG. 7 comprises a grip portion 51, two mounting members 511 mounted on two opposite ends of the grip portion 51 and each having a distal end provided with a threaded locking portion 512, two nuts 53 each screwed onto the respective locking portion 512, and two washers 52 each mounted on the respective locking portion 512 and each located between the respective mounting member 511 and the respective nut 53. In assembly, when the grip portion 51 is mounted on an object, such as a wardrobe, cupboard, door, drawer, cabinet and the like, the locking portion 512 is extended through a drilled bore of the object until the mounting member 511 abuts one side of the object. Then, each of the washers 52 is mounted on the respective locking portion 512 and abuts the other side of the object. Then, each of the nuts 53 is screwed onto the respective locking portion 512 and presses the respective washer 52 to tighten the respective mounting member 511 so as to attach the grip portion 51 of the handle “B” to the object. However, the grip portion 51 is fixed on and exposed outward from the object, so that when the grip portion 51 is hit by a person unintentionally, the person is easily hurt due to hit with the grip portion 51.

### BRIEF SUMMARY OF THE INVENTION

In accordance with the present invention, there is provided a foldable handle, comprising a grip portion, two pivot units each pivotally connected with the grip portion, two support members each mounted between the grip portion and a respective one of the pivot units, and two elastic members each biased between a respective one of the pivot units and a respective one of the support members. The grip portion has two opposite ends each provided with a first through hole and an abutting face. Each of the pivot units includes a base pivotally connected with the grip portion, and a connecting member extended through the base and the grip portion to connect the base with the grip portion. The base of each of the pivot units has an interior provided with a receiving chamber to receive each of the two opposite ends of the grip portion. The base of each of the pivot units has a periphery provided with an opening to allow passage of the grip portion. Each of the two opposite ends of the grip portion is received in the receiving chamber of the base of a respective one of the pivot units. The receiving chamber of the base of each of the pivot units has two opposite sides each provided with a second through hole. The receiving chamber of the base of each of the pivot units has a bottom wall provided with a receiving groove to receive a respective one of the support members. The receiving groove of the base of each of the pivot units has a bottom wall provided with a receiving recess to receive a respective one of the elastic members. The base of each of the pivot units has a bottom provided with a threaded locking portion which is connected with a washer and a nut. The connecting member of each of the pivot units is extended through the respective second through hole of the base and the respective first through hole of the grip portion so that the base of each of the pivot units is pivotally connected with the grip portion. Each of the support members is movably mounted in the receiving groove of the base of the respective pivot unit. Each of the support members has a top abutting the respective abutting face of the grip portion and has a bottom provided with a protrusion pressing the respective elastic member. Each of the elastic members is mounted in the receiving recess of the base of the respective pivot unit. Each of the elastic members has an upper end pressing the protrusion of the respective support member and a lower end pressing the base of the respective pivot unit.

Preferably, the second through hole of the base of each of the pivot units is aligned and concentric with the respective first through hole of the grip portion. The connecting member of each of the pivot units functions as a pivoting fulcrum of the grip portion relative to the base of each of the pivot units.

Preferably, each of the support members is pressed and moved by the respective abutting face of the grip portion when the grip portion is moved relative to the base of each of the pivot units so as to compress the respective elastic member so that the grip portion is rotated relative to the base of each of the pivot units until the grip portion is disposed at a folded state.

Preferably, the connecting member of each of the pivot units is a pin.

The primary objective of the present invention is to provide a foldable handle that is folded when being hit or collided.

According to the primary advantage of the present invention, when the grip portion is hit by a person unintentionally, the grip portion is moved and rotated relative to the base of each of the pivot units freely to reach a folded state so as to prevent the person from being hurt due to hit with the grip portion.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a foldable handle in accordance with the preferred embodiment of the present invention.

FIG. 2 is an exploded perspective view of the foldable handle as shown in FIG. 1.

FIG. 3 is a front cross-sectional view of the foldable handle as shown in FIG. 1.

FIG. 4 is a schematic operational view of the foldable handle as shown in FIG. 1 in use.

FIG. 5 is a side cross-sectional view of the foldable handle as shown in FIG. 4.

FIG. 6 is a locally enlarged view of the foldable handle as shown in FIG. 5.

FIG. 7 is a perspective view of a conventional handle in accordance with the prior art.

### DETAILED DESCRIPTION OF THE INVENTION

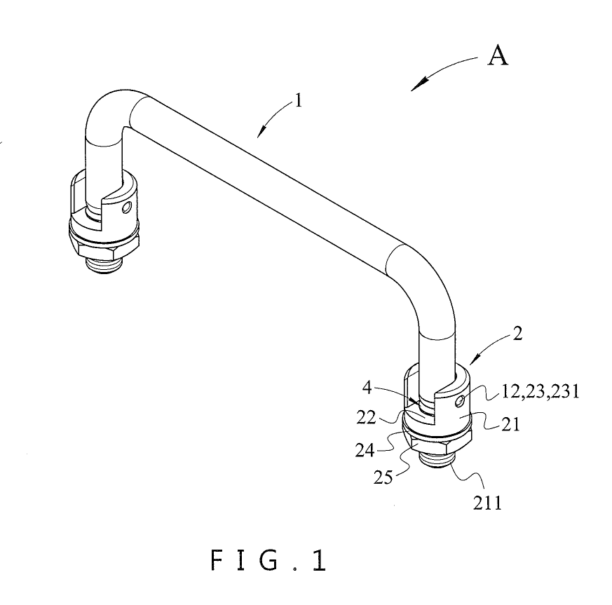

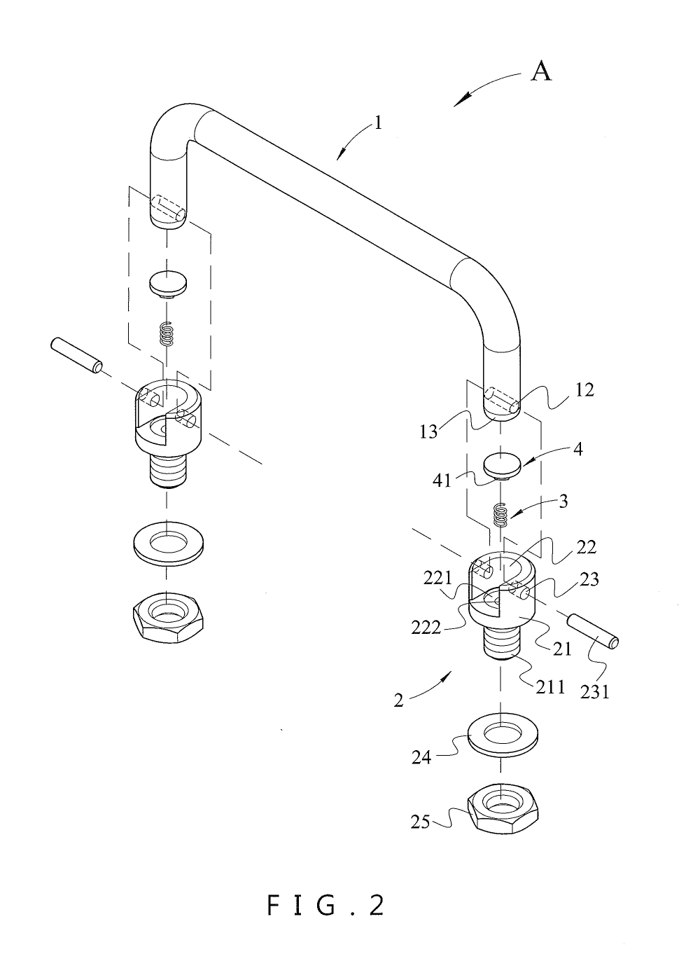

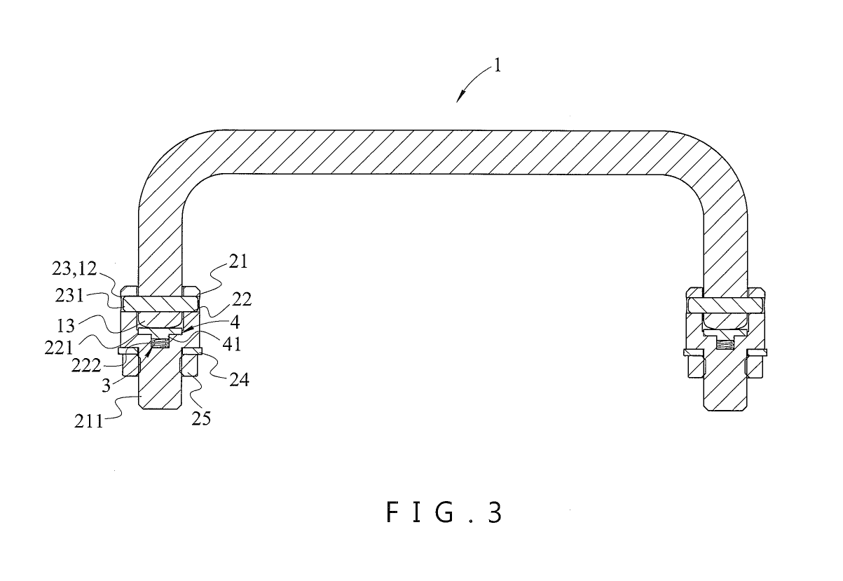

Referring to the drawings and initially to FIGS. 1-3, a foldable handle “A” in accordance with the preferred embodiment of the present invention comprises a grip portion 1, two pivot units 2 each pivotally connected with the grip portion 1, two support members 4 each mounted between the grip portion 1 and a respective one of the pivot units 2, and two elastic members 3 each biased between a respective one of the pivot units 2 and a respective one of the support members 4.

The grip portion 1 has a substantially inverted U-shaped profile and has two opposite ends each provided with a first through hole 12 and an abutting face 13. The abutting face 13 of the grip portion 1 has an arcuate shape.

Each of the pivot units 2 includes a base 21 pivotally connected with the grip portion 1, and a connecting member 231 extended through the base 21 and the grip portion 1 to connect the base 21 with the grip portion 1.

The base 21 of each of the pivot units 2 has an interior provided with a receiving chamber 22 to receive each of the two opposite ends of the grip portion 1. The base 21 of each of the pivot units 2 has a periphery provided with an opening to allow passage of the grip portion 1. Each of the two opposite ends of the grip portion 1 is received in the receiving chamber 22 of the base 21 of a respective one of the pivot units 2 and is allowed to pass through the opening of the base 21 of the respective pivot unit 2. The receiving chamber 22 of the base 21 of each of the pivot units 2 has two opposite sides each provided with a second through hole 23. The second through hole 23 of the base 21 of each of the pivot units 2 is aligned and concentric with the respective first through hole 12 of the grip portion 1. The receiving chamber 22 of the base 21 of each of the pivot units 2 has a bottom wall provided with a receiving groove 221 to receive a respective one of the support members 4. The receiving groove 221 of the base 21 of each of the pivot units 2 has a bottom wall provided with a receiving recess 222 to receive a respective one of the elastic members 3. The base 21 of each of the pivot units 2 has a bottom provided with a threaded locking portion 211 which is connected with a washer 24 and a nut 25. In assembly, the threaded locking portion 211 of the base 21 of each of the pivot units 2 is mounted on an object and is tightened and locked by the washer 24 and the nut 25 so as to attach the foldable handle “A” to the object.

The connecting member 231 of each of the pivot units 2 is extended through the respective second through hole 23 of the base 21 and the respective first through hole 12 of the grip portion 1 so that the base 21 of each of the pivot units 2 is pivotally connected with the grip portion 1. Preferably, the connecting member 231 of each of the pivot units 2 is a pin to function as a pivoting fulcrum of the grip portion 1 relative to the base 21 of each of the pivot units 2.

Each of the support members 4 has a disk shape and is movably mounted in the receiving groove 221 of the base 21 of the respective pivot unit 2. Each of the support members 4 has a top abutting the respective abutting face 13 of the grip portion 1 and has a bottom provided with a protrusion 41 pressing the respective elastic member 3. The protrusion 41 of each of the support members 4 is extended into the receiving recess 222 of the base 21 of the respective pivot unit 2.

Each of the elastic members 3 is mounted in the receiving recess 222 of the base 21 of the respective pivot unit 2. Each of the elastic members 3 has an upper end pressing the protrusion 41 of the respective support member 4 and a lower end pressing the base 21 of the respective pivot unit 2.

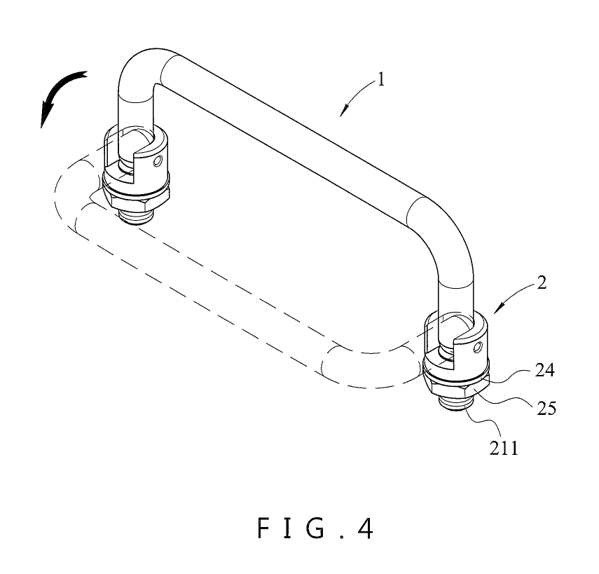

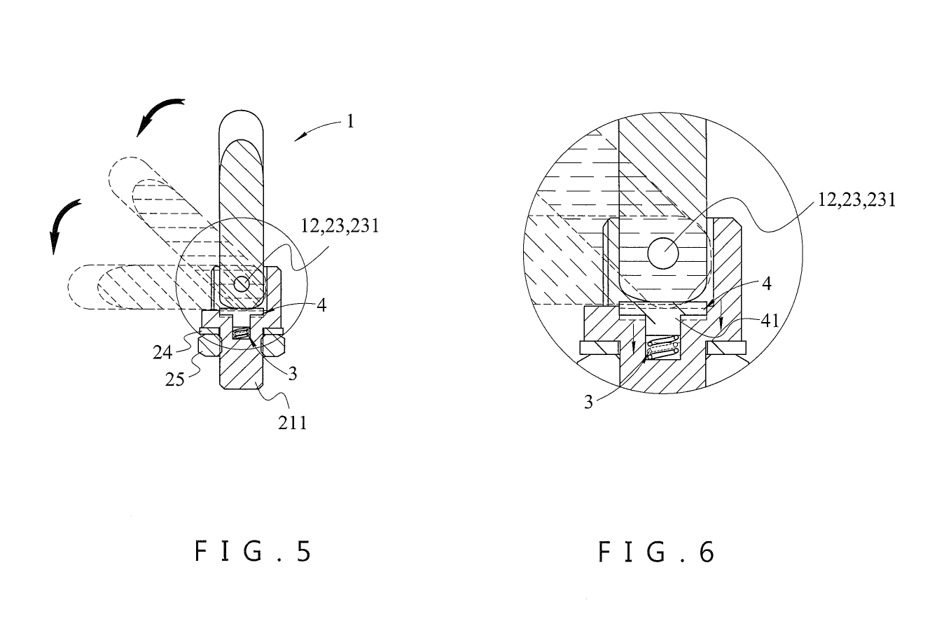

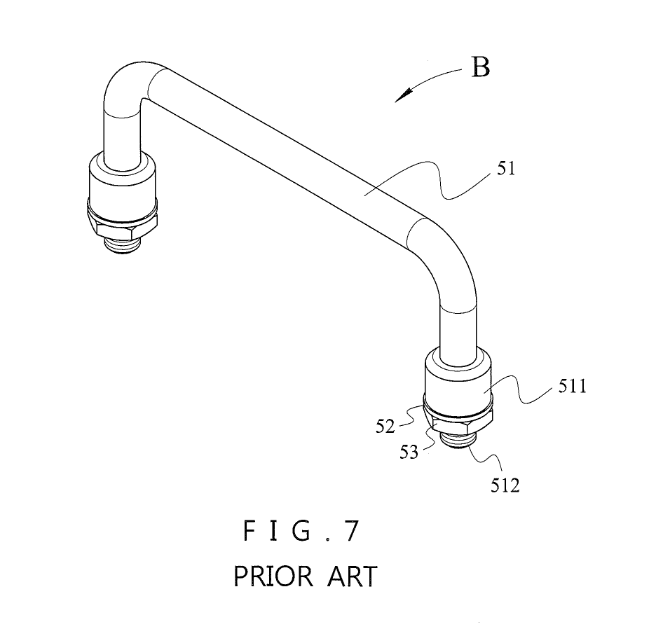

In operation, referring to FIGS. 4-6 with reference to FIGS. 1-3, each of the support members 4 is pressed and moved by the respective abutting face 13 of the grip portion 1 when the grip portion 1 is moved relative to the base 21 of each of the pivot units 2 so as to compress the respective elastic member 3 so that the grip portion 1 is rotated relative to the base 21 of each of the pivot units 2 as shown in FIGS. 4-6 until the grip portion 1 is disposed at a folded state. Accordingly, when the grip portion 1 is hit by a person unintentionally, the grip portion 1 is moved and rotated relative to the base 21 of each of the pivot units 2 freely to reach a folded state so as to prevent the person from being hurt due to hit with the grip portion 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A foldable handle, comprising:
a grip portion;
two pivot units each pivotally connected with the grip portion;
two support members each mounted between the grip portion and a respective one of the pivot units; and
two elastic members each biased between a respective one of the pivot units and a respective one of the support members;
wherein the grip portion has two opposite ends each provided with a first through hole and an abutting face;
each of the pivot units includes a base pivotally connected with the grip portion, and a connecting member extended through the base and the grip portion to connect the base with the grip portion;
the base of each of the pivot units has an interior provided with a receiving chamber to receive each of the two opposite ends of the grip portion;
the base of each of the pivot units has a periphery provided with an opening to allow passage of the grip portion;
each of the two opposite ends of the grip portion is received in the receiving chamber of the base of a respective one of the pivot units;
the receiving chamber of the base of each of the pivot units has two opposite sides each provided with a second through hole;
the receiving chamber of the base of each of the pivot units has a bottom wall provided with a receiving groove to receive a respective one of the support members;
the receiving groove of the base of each of the pivot units has a bottom wall provided with a receiving recess to receive a respective one of the elastic members;
the base of each of the pivot units has a bottom provided with a threaded locking portion which is connected with a washer and a nut;
the connecting member of each of the pivot units is extended through the respective second through hole of the base and the respective first through hole of the grip portion so that the base of each of the pivot units is pivotally connected with the grip portion;
each of the support members is movably mounted in the receiving groove of the base of the respective pivot unit;
each of the support members has a top abutting the respective abutting face of the grip portion and has a bottom provided with a protrusion pressing the respective elastic member;
each of the elastic members is mounted in the receiving recess of the base of the respective pivot unit; and
each of the elastic members has an upper end pressing the protrusion of the respective support member and a lower end pressing the base of the respective pivot unit.

2. The foldable handle of claim 1, wherein
the second through hole of the base of each of the pivot units is aligned and concentric with the respective first through hole of the grip portion; and
the connecting member of each of the pivot units functions as a pivoting fulcrum of the grip portion relative to the base of each of the pivot units.

3. The foldable handle of claim 1, wherein each of the support members is pressed and moved by the respective abutting face of the grip portion when the grip portion is moved relative to the base of each of the pivot units so as to compress the respective elastic member so that the grip portion is rotated relative to the base of each of the pivot units until the grip portion is disposed at a folded state.

4. The foldable handle of claim 1, wherein the connecting member of each of the pivot units is a pin.
